(19) United States
(12) Patent Application Publication
(10) Pub. No.: US 2025/0004926 A1
(43) Pub. Date: Jan. 2, 2025

(54) API Validation Framework

(71) Applicant: Procore Technologies, Inc., Carpinteria, CA (US)

(72) Inventors: Oscar Gracia, Ventura, CA (US); Michael Graf, Austin, TX (US); Daniel Porrello, Miami, FL (US); Gaurav Sharma, Austin, TX (US)

(21) Appl. No.: 18/343,076

(22) Filed: Jun. 28, 2023

(51) Int. Cl. G06F 11/36; G06F 9/54

(52) U.S. Cl. CPC G06F 11/3684; G06F 9/54

(57) ABSTRACT

An example computing system is configured to (i) receive information indicating a set of tests, each test comprising a request to and response from an API that collectively define an API test contract, (ii) based on the set of tests, determine a set of API test contracts, (iii) receive information indicating API production traffic comprising a set of requests to, and responses from, the API, wherein each production request and corresponding production response collectively define an API production contract, (iv) based on the production traffic for the API, determine a set of API production contracts, (v) compare the API test contracts with the API production contracts, (vi) based on the comparison, determine an inconsistency between the sets of API contracts; and (vii) based on the determined inconsistency, cause a change in (a) an extent of the set of tests, or (b) an extent of functionality of the API.

### BACKGROUND

APIs are an important tool for any provider of software services. As APIs provide a mechanism for interacting with software services, it is important that those who will interact with the software services, particularly developers of the software service as well as consumers of the software services, be given resources to understand the capacities and limits of the API for the software services. Accordingly, the documentation of APIs is an area of great importance, particularly for APIs that support large, robust software services. If the documentation of APIs is accurate and available, users of the API, whether developers or consumers of software services, will be better able to understand and implement the various functionalities of the API, as well as the proper methods of activating said functionalities.

### OVERVIEW

Organizations that offer software as a service (SaaS organizations) typically employ a suite of software tools as part of their offerings. These software tools may work independently, or synergistically with each other, and in some instances may interact with each other. To enable functionality of said software tools, SaaS organizations rely on Application Programming Interfaces (APIs), which provide a mechanism for connection to and between the various software tools of the SaaS organizations.

As one example, Procore Technologies, Inc. provides a global enterprise ready platform that offers a host of software services within the construction management space. To enable functionality of these software services, Procore developed the Procore API, which is made up of a number of API endpoints that each defines a respective operation of the API. These endpoints may optionally be private or public, and may be used by external and internal consumers of Procore's API. External consumers may include Procore customers that use Procore's software services via the Procore API. External consumers may also include software developers, as well as software applications themselves, that are not directly associated with Procore Technologies, Inc., but that may nonetheless utilize certain portions of the Procore API. For example, external consumers may access public endpoints of the Procore API to interact with Procore's software services for a variety of purposes, such as to use and/or create custom integration tools for interacting with the various software services via the Procore API. Such custom integration tools may be offered in a Procore marketplace or the like to provide consumers-both external and internal-with access to the integration tools to interact with Procore's software services via the Procore API in ways that are tailored to the consumers' specific needs. Internal consumers, on the other hand, may be Procore users, software developers, and/or software applications that are directly associated with Procore Technologies, Inc. and that have access to both public and private endpoints of the Procore API. These internal consumers may be engaged in various tasks, such as building, maintaining, and/or using the functionality for various Procore applications (e.g., mobile and web-based applications), as well as building, maintaining, and/or using custom integration tools for Procore's external consumers, as previously described.

Each of these parties (external consumers and internal consumers), and by extension end-users of Procore's services as well as the Procore organization as a whole, rely on the accessibility and functionality of the Procore API, as it is the mechanism that enables interaction with Procore's software services. Further, the Procore API, as with an API of any large-scale SaaS organization, may include a large number of endpoints, each with various parameters that define their respective functionality. Accordingly, it is vital that recordation of the various endpoints of Procore's API be available, accurate, and comprehensive, so that users of the Procore API can rely on documentation for various endpoints of the API to guide their interactions with the Procore API.

To this end, Procore has developed an Open API Specification (OAS) that describes the endpoints of the Procore API in a format that is both human-readable and software-readable. The OAS may be used by human consumers (external and internal) of Procore's API to (i) discover and learn what endpoints are available for their use, (ii) know how to implement a given endpoint of the API (e.g., what parameters are acceptable/required by the given endpoint), and (iii) know what to expect when implementing a given endpoint (e.g., what types of responses are returned by implementing the given endpoint), among various other things. Further, the OAS may be used by software consumers (external and internal) of Procore's API for various purposes, as described below.

As described, it is important that the OAS be an accurate and comprehensive representation of Procore's API. Similarly, it is important to have accurate and comprehensive testing of the API, and that such testing be in line with the OAS. These requirements help ensure that the OAS may be relied on by users of the Procore API to guide their interactions with API.

However, there are various challenges associated with (i) maintaining an up-to-date OAS that accurately and comprehensively represents an API and (ii) verifying that testing of the API is accurate, complete, and in line with the OAS. This is particularly true for large-scale APIs, such as Procore's API, as well as other SaaS organizations that offer large suites of software services.

One such challenge is that APIs are dynamic, as new endpoints may be defined for an API and features for existing endpoints of the API may be adjusted from time to time. If these changes are not reflected in an OAS for the API, then users of the API will not be aware of such changes and may not be able to successfully interact with the API endpoints, for example when a required parameter for calling a given endpoint of the API has changed. Consequences of these changes are also prone to being compounded, because software that implements adjusted endpoints may also be affected by the changes of the endpoints. Unless the OAS for the API is updated to reflect changes to the endpoints, developers will be left without resources to identify why software implementing the adjusted endpoints is behaving differently.

Further, the existing methods for testing and validating APIs have several limitations as well. For example, although a developer may create and run tests for endpoints in an API, in practice, the tests that are generated by developers of the API tend to focus on certain groups of endpoints, such as the endpoints that the developer finds most significant or the most likely to be used in practice. This may lead to some endpoints being highly tested, while leaving other endpoints relatively untested. Further, developer-generated tests may be faulty, and may either not operate as intended or may not test certain behaviors of the endpoint that they reference.

Developers may also utilize API validation software to help fill in the gaps in developer-generated testing. However, current API validation software is ineffective at providing a comprehensive tool for validation of various aspects of an API. For example, current API validation software may verify that developer-generated tests are accurate and in accordance with the OAS for a given API, but may not identify the absence of tests for various portions of the OAS. This patchwork validation of APIs is incomplete and does not promote a high level of confidence that API documentation is comprehensive and up-to-date, as is needed, particularly for large, robust APIs.

To address these problems and others, disclosed herein is a holistic API validation suite that performs a number of tests on an API of a software service to identify issues that may exist in the software service's API, such as (i) insufficient or inaccurate testing for various aspects of the software service's API, (ii) insufficient or inaccurate documentation for various aspects of the software service's API, and/or (iii) a lack of utility of various aspects of the software service's API in production, among various other issues that a provider of the software service may desire to be aware of. In this respect, the disclosed software technology provides a holistic solution that can identify issues in a software service to assist a provider of the software service in maintaining the API of their software service.

At a high level, the disclosed API validation suite enables a computing device, such as a back-end platform, to employ various validation tools of the API validation suite to test various aspects of an API and provide feedback and solutions to enhance the testing and documentation of the API. In some implementations, some or all of the tools of the API validation suite may operate individually, to test respective aspects of the API. Additionally or alternatively, in some implementations, some or all of the tools of the API validation suite and the tools may synergistically work together to provide a comprehensive validation of the API. Various examples of such synergy are described below. To test the various aspects of the API using the API validation suite, the computing device may ingest various types of information related to the API. Such information may include (i) information indicating an OAS of the API, which may describe the various endpoints of the API, (ii) information indicating tests that have been created for the API, whether developer-generated or otherwise, which may include test requests and responses for endpoints of the API (e.g., expected responses as well as actual responses), and (iii) information indicating production traffic of the API, including requests to and responses from various endpoints of the API, among various other possibilities. It should be noted that although a single OAS is described for the API, there may be numerous OASes for the API. As one example, there may be a respective OAS for each endpoint of the API. As another example, there may be a respective OAS for different categories of endpoints of the API, such as endpoints that facilitate a given portion of the software service that the API interacts with. Various other examples may also exist.

The computing device may then utilize the various tools of the API validation suite to run comparisons between various of the ingested information to (i) automatically generate tests for portions of the OAS that may be missing, incomplete, or faulty in existing tests for the API, (ii) determine the surface area of the API, as well as portions of the surface area of the API that are not adequately tested, and/or (iii) determine differences between test contracts identified from the information indicating the tests that have been created for the API and production contracts identified from the information indicating the production traffic of the API, among various other things.

Accordingly, in one aspect, disclosed herein is a method that involves (i) receiving information indicating a set of tests that have been performed for an API, each test comprising a respective request to the API and a respective response from the API that collectively define an API test contract, (ii) based on the set of tests, determining a set of API test contracts, (iii) receiving information indicating production traffic for the API, the production traffic comprising a set of requests to, and corresponding production responses from, the API, wherein each respective production request and corresponding production response collectively define an API production contract, (iv) based on the production traffic for the API, determining a set of API production contracts, (v) comparing the set of API test contracts with the set of API production contracts, (vi) based on the comparison, determining an inconsistency between the set of API test contracts and the set of API production contracts, and (vii) based on the determined inconsistency, causing a change in (a) an extent of the set of tests that have been performed for the API, or (b) an extent of functionality of the API.

In another aspect, disclosed herein is a computing system that includes a network interface, at least one processor, a non-transitory computer-readable medium, and program instructions stored on the non-transitory computer-readable medium that are executable by the at least one processor to cause the computing system to carry out the functions disclosed herein, including but not limited to the functions of the foregoing methods.

In yet another aspect, disclosed herein is a non-transitory computer-readable storage medium provisioned with software that is executable to cause a computing system to carry out the functions disclosed herein, including but not limited to the functions of the foregoing methods.

One of ordinary skill in the art will appreciate these as well as numerous other aspects in reading the following disclosure.

### BRIEF DESCRIPTION OF THE DRAWINGS

FIG. 1 depicts an example network configuration in which example embodiments may be implemented.

FIG. 2 depicts an example computing platform that may be configured to carry out one or more of the functions of the present disclosure.

FIG. 3 depicts an example computing platform including an API validation suite that may be configured to carry out one or more of the functions of the present disclosure.

FIG. 4 depicts an example computing platform that may be configured to perform operations of an auto-test creation tool of the computing platform, according to the present disclosure.

FIG. 5 is a flowchart that illustrates various operations that may be carried out via the auto-test creation tool of FIG. 4, according to the present disclosure.

FIG. 6 depicts an example computing platform that may be configured to perform operations of a surface area test coverage tool of the computing platform, according to the present disclosure.

FIG. 7 is a flowchart that illustrates various operations that may be carried out via the surface area test coverage tool of FIG. 6, according to the present disclosure.

FIG. 8 depicts an example computing platform that may be configured to perform operations of a test versus production comparison tool of the computing platform, according to the present disclosure.

FIG. 9 is a flowchart that illustrates various operations that may be carried out via the test versus production comparison tool of FIG. 8, according to the present disclosure.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### DETAILED DESCRIPTION

The following disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners, each of which is contemplated herein.

### I. Example System Configuration

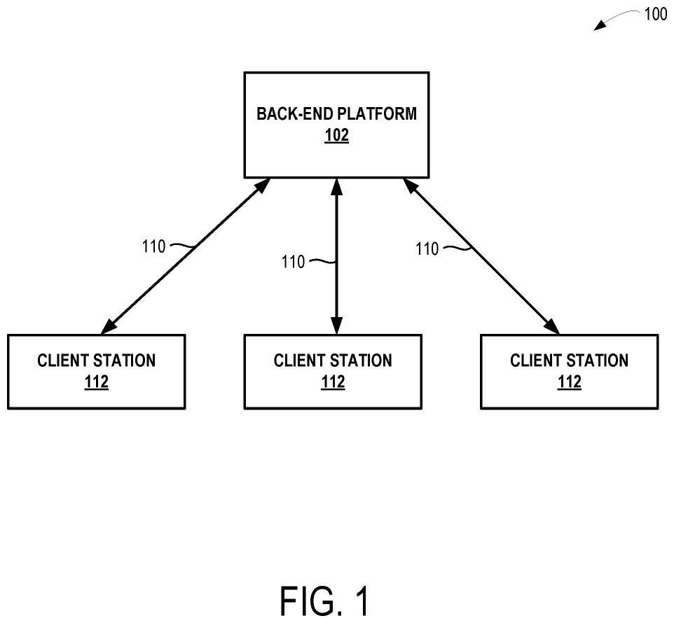

Turning now to the figures, FIG. 1 depicts an example network configuration 100 in which example embodiments of the present disclosure may be implemented. As shown in FIG. 1, the network configuration 100 includes a back-end platform 102 that may be communicatively coupled to one or more client stations, depicted here, for the sake of discussion, as three client stations 112.

In general, the back-end platform 102 may comprise one or more computing systems that have been provisioned with software for carrying out one or more of the platform functions disclosed herein, including but not limited to functions related to the disclosed process of validating an API of a software service. The one or more computing systems of the back-end platform 102 may take various forms and be arranged in various manners.

For instance, as one possibility, the back-end platform 102 may comprise computing infrastructure of a public, private, and/or hybrid cloud (e.g., computing and/or storage clusters) that has been provisioned with software for carrying out one or more of the platform functions disclosed herein. In this respect, the entity that owns and operates the back-end platform 102 may either supply its own cloud infrastructure or may obtain the cloud infrastructure from a third-party provider of “on demand” computing resources, such include Amazon Web Services (AWS) or the like. As another possibility, the back-end platform 102 may comprise one or more dedicated servers that have been provisioned with software for carrying out one or more of the platform functions disclosed herein. Other implementations of the back-end platform 102 are possible as well.

In turn, the client stations 112 may each be any computing device that is capable of running the front-end software disclosed herein. In this respect, the client stations 112 may each include hardware components such as a processor, data storage, a user interface, and a network interface, among others, as well as software components that facilitate the client station's ability to run the front-end software disclosed herein (e.g., operating system software, web browser software, etc.). As representative examples, the client stations 112 may each take the form of a desktop computer, a laptop, a netbook, a tablet, a smartphone, and/or a personal digital assistant (PDA), among other possibilities.

As further depicted in FIG. 1, the back-end platform 102 is configured to interact with one or more of the client stations 112 over respective communication paths 110. Each communication path 110 between the back-end platform 102 and one of the client stations 112 may generally comprise one or more communication networks and/or communications links, which may take any of various forms. For instance, each respective communication path 110 with the back-end platform 102 may include any one or more of point-to-point links, Personal Area Networks (PANs), Local-Area Networks (LANs), Wide-Area Networks (WANs) such as the Internet or cellular networks, cloud networks, and/or operational technology (OT) networks, among other possibilities. Further, the communication networks and/or links that make up each respective communication path 110 with the back-end platform 102 may be wireless, wired, or some combination thereof, and may carry data according to any of various different communication protocols. Although not shown, the respective communication paths 110 with the back-end platform 102 may also include one or more intermediate systems. For example, it is possible that the back-end platform 102 may communicate with a given client station 112 via one or more intermediary systems, such as a host server (not shown). Many other configurations are also possible.

The interaction between the client stations 112 and the back-end platform 102 may take various forms. As one possibility, the client stations 112 may send certain user input related to an API of a software service to the back-end platform 102, which may in turn trigger the back-end platform 102 to take one or more actions based on the user input, including validating the API through the performance of various validation operations, as discussed herein. As another possibility, the client stations 112 may send a request to the back-end platform 102 for certain API validation status data and/or a certain front-end software module, and the client stations 112 may then receive API validation status data (and perhaps related instructions) from the back-end platform 102 in response to such a request. As yet another possibility, the back-end platform 102 may be configured to “push” certain types of API validation status information to the client stations 112, such as API validation status data, in which case the client stations 112 may receive API validation status data (and perhaps related instructions) from the back-end platform 102 in this manner. As still another possibility, the back-end platform 102 may be configured to make certain types of API validation status data available via an API, a service, or the like, in which case the client stations 112 may receive API validation status data from the back-end platform 102 by accessing such an API or subscribing to such a service. The interaction between the client stations 112 and the back-end platform 102 may take various other forms as well.

In practice, the client stations 112 may each be operated by and/or otherwise associated with a different individual that is associated with an API of a software service. For example, an individual tasked with a first portion of the API of the software service may access one of the client stations 112, whereas an individual tasked a second portion of the API of the software service may access another of the client stations 112. The client stations 112 may be operated by and/or otherwise associated with individuals having various other roles with respect to the software service as well. Further, while FIG. 1 shows an arrangement in which three particular client stations are communicatively coupled to the back-end platform 102, it should be understood that a given arrangement may include more or fewer client stations.

Although not shown in FIG. 1, the back-end platform 102 may also be configured to receive API-related data from one or more external data sources, such as an external database and/or another back-end platform or platforms. Such data sources-and the API-related data output by such data sources-may take various forms.

It should be understood that the network configuration 100 is one example of a network configuration in which embodiments described herein may be implemented. Numerous other arrangements are possible and contemplated herein. For instance, other network configurations may include additional components not pictured and/or more or less of the pictured components.

### II. Example Computing Devices

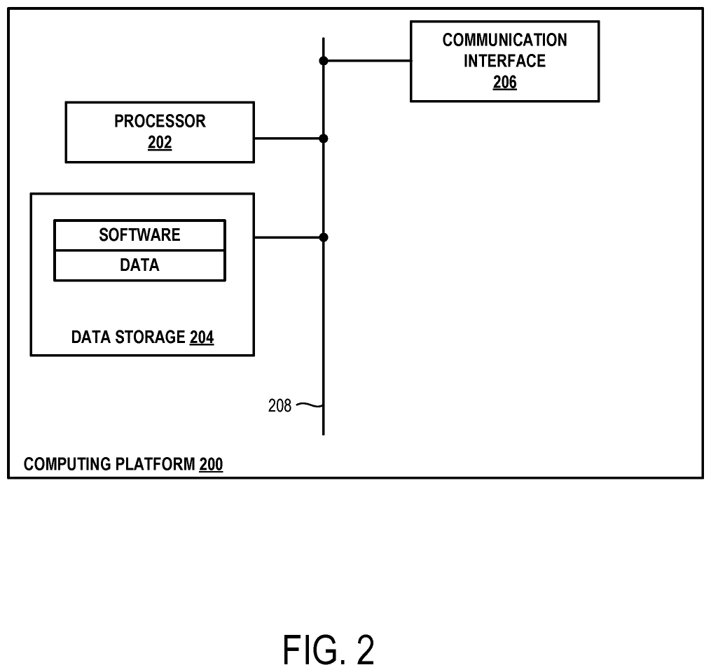

FIG. 2 is a simplified block diagram illustrating some structural components that may be included in an example computing platform 200, which could serve as, for instance, one or more of the client stations 112 in FIG. 1. In line with the discussion above, the computing platform 200 may generally include at least a processor 202, data storage 204, and a communication interface 206, all of which may be communicatively linked by a communication link 208 that may take the form of a system bus or some other connection mechanism.

The processor 202 may comprise one or more processor components, such as general-purpose processors (e.g., a single-or multi-core microprocessor), special-purpose processors (e.g., an application-specific integrated circuit or digital-signal processor), programmable logic devices (e.g., a field programmable gate array), controllers (e.g., microcontrollers), and/or any other processor components now known or later developed. In line with the discussion above, it should also be understood that the processor 202 could comprise processing components that are distributed across a plurality of physical computing devices connected via a network, such as a computing cluster of a public, private, or hybrid cloud.

In turn, the data storage 204 may comprise one or more non-transitory computer-readable storage mediums, examples of which may include volatile storage mediums such as random-access memory, registers, cache, etc., and non-volatile storage mediums such as read-only memory, a hard-disk drive, a solid-state drive, flash memory, an optical-storage device, etc. In line with the discussion above, it should also be understood that the data storage 204 may comprise computer-readable storage mediums that are distributed across a plurality of physical computing devices connected via a network, such as a storage cluster of a public, private, or hybrid cloud.

As shown in FIG. 2, the data storage 204 may be provisioned with software components that enable the computing platform 200 to carry out the platform-side functions disclosed herein. These software components may generally take the form of program instructions that are executable by the processor 202 to carry out the disclosed functions, which may be arranged together into software applications, virtual machines, software development kits, toolsets, or the like, all of which are referred to herein as a software tool or software tools. Further, the data storage 204 may be arranged to store API-related data in one or more databases, file systems, or the like. The data storage 204 may take other forms and/or store data in other manners as well.

The communication interface 206 may be configured to facilitate wireless and/or wired communication with other computing devices or systems, such as one or more client stations 112 when the computing platform 200 serves as the back-end platform 102, or the back-end platform 102 when the computing platform 200 serves as one of the client stations 112. Additionally, in an implementation where the computing platform 200 comprises a plurality of physical computing devices connected via a network, the communication interface 206 may be configured to facilitate wireless and/or wired communication between these physical computing devices (e.g., between computing and storage clusters in a cloud network). As such, the communication interface 206 may take any suitable form for carrying out these functions, examples of which may include an Ethernet interface, a serial bus interface (e.g., Firewire, USB 3.0, etc.), a chipset and antenna adapted to facilitate wireless communication, and/or any other interface that provides for wireless and/or wired communication. The communication interface 206 may also include multiple communication interfaces of different types. Other configurations are possible as well.

Although not shown, the computing platform 200 may additionally include one or more interfaces that provide connectivity with external user-interface equipment (sometimes referred to as “peripherals”), such as a keyboard, a mouse or trackpad, a display screen, a touch-sensitive interface, a stylus, a virtual-reality headset, speakers, etc., which may allow for direct user interaction with the computing platform 200.

It should be understood that the computing platform 200 is one example of a computing device that may be used with the embodiments described herein. Numerous other arrangements are possible and contemplated herein. For instance, other computing devices may include additional components not pictured and/or more or fewer of the pictured components.

### III. Example Operations

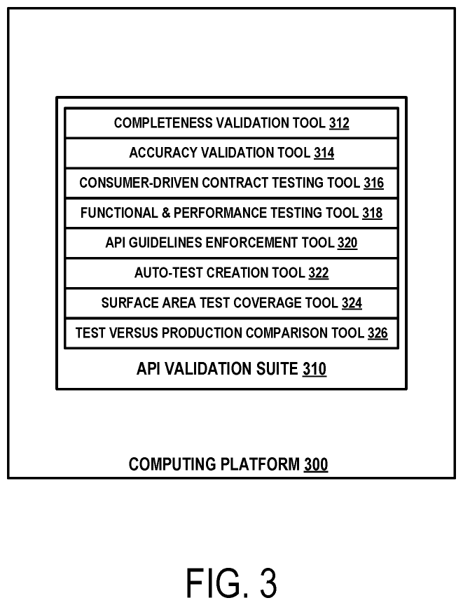

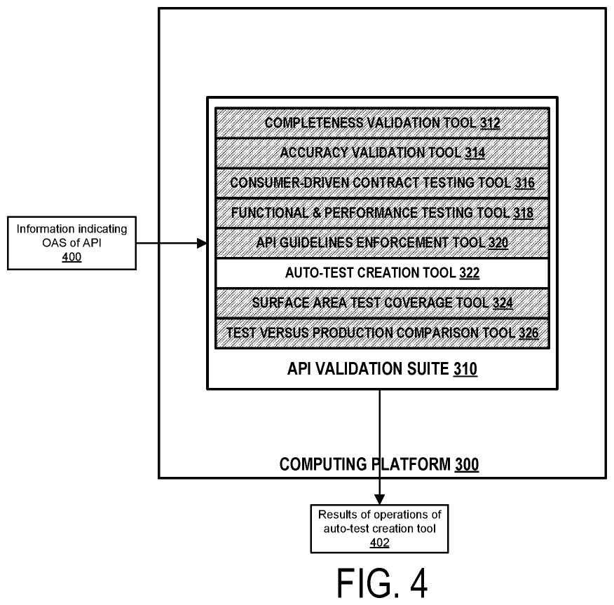

FIG. 3 is a simplified block diagram illustrating an example computing platform 300 including an API validation suite 310 that may be configured to carry out one or more of the functions of the present disclosure. The computing platform 300 could serve as, for instance, the back-end platform 102. Although not shown, the computing platform 300 may include processors, data storage, and communication interfaces, among other things, as described with respect to the computing platform 200 of FIG. 2. As mentioned, the computing platform 300 may include the API validation suite 310, which may be configured to perform validation operations to test an API associated with the computing platform 300. Accordingly, the API validation suite 310 may comprise various tools that each enable a respective set of operations to validate a respective aspect of the API. Such tools may include (i) a completeness validation tool 312, (ii) an accuracy validation tool 314, (iii) a consumer-driven contract testing tool 316, (iv) a functional and performance testing tool 318, (v) an API guidelines enforcement tool 320, (vi) an auto-test creation tool 322, (ii) a surface area test coverage tool 324, and (iii) a test versus production comparison tool 326, among various other possible validation tools. Each of the tools 312-320 are described in greater detail below with respect to the FIG. 3, and the tools 322-326 are described in further detail with respect to FIGS. 4-9. Further, it should be understood that, depending on the implementation, the operations discussed below regarding the various tools 312-326 may be carried out entirely by a single computing device or may be carried out by a combination of computing devices, with some operations being carried out by the back-end platform 102 (such as computational processes and data-access operations) and other operations being carried out by one or more of the client stations 112 (such as display operations and operations that receive user inputs). However, other arrangements are possible as well.

As previously described, the computing platform 300 may employ the API validation suite 310 to perform a holistic validation of an API, for example, an API of a software service that provides a variety of software programs. This validation of the API may be accomplished via utilization of the various tools 312-326 of the API validation suite 310.

Beginning with the completeness validation tool 312 of the API validation suite 310, the computing platform 300 may, via the completeness validation tool 312, confirm that each endpoint of the API has a complete description in an OAS of the API. This may be done by (i) receiving information indicating the OAS of the API, (ii) generating paths and parameters for endpoints of the API, (iii) comparing the generated paths and parameters for the endpoints of the API with the information indicating the OAS of the API, and then (iv) reporting results of the comparison, which may indicate inconsistencies between service paths of the API and the OAS, to developers of the API to inform them of portions of the API that are not represented in the OAS.

Turning now to the accuracy validation tool 314 of the API validation suite 310, the computing platform 300 may, via the accuracy validation tool 314, confirm that tests created for the API are accurate. These tests may be generated by developers of the API as they are creating endpoints of the API to ensure that the endpoints function properly, and may each include a request to an endpoint of the API, as well as an expected response from the API. Accordingly, the computing platform 300 may, via the accuracy validation tool 314, confirm the accuracy of the tests created for the API by (i) ingesting information indicating the requests and responses of the tests created for the API, (ii) ingesting information indicating the OAS of the API, (iii) comparing the information indicating the tests created for the API with the information indicating the OAS of the API to determine matches between the tests and the OAS, and (iv) report results of the comparison to a developer of the API, which may include (a) confirmation of matches found in the comparison, as well as (b) identification of any inconsistencies found in the comparison.

Turning next to the consumer-driven contract testing tool 316 of the API validation suite 310, the computing platform 300 may, via the consumer-driven contract testing tool 316, create and run consumer-driven contract tests to ensure that API contracts between consumers and provider services are not broken. A contract may be defined as a request and an expected response pair for a given endpoint of the API. For example, when a user calls a given endpoint with a given set of parameters in the call request, the user may expect a reliable response from the endpoint that matches the request to be returned. Although the exact values may change from response to response, (e.g., a request for the most recent data at one time and then another request for the most recent data at a second time may have different responses due to new data being created in between the two requests) the user should at least be able to rely on the endpoint to perform consistently between requests. Accordingly, the computing platform 300 may, via the consumer-driven contract testing tool 316 of the API validation suite 310, manage contracts for the various endpoints of the API and transmit an alert when a contract is broken (e.g., when an endpoint returns an unexpected response based on a request to the endpoint of the API).

Turning next to the functional and performance testing tool 318 of the API validation suite 310, the computing platform 300 may, via the functional and performance testing tool 318, perform API functional and performance testing. In practice, the functional and performance testing tool 318 may provide a method and tooling to perform functional and performance testing of the API, with flexibility to execute in any development area, utilizing service isolation as desired. This tool may test the API's performance in several areas, such as load, volume, stress, chaos, and scalability.

Turning next to the API guidelines enforcement tool 320 of the API validation suite 310, the computing platform 300 may, via the API guidelines enforcement tool 320, ensure that developers creating endpoints for the API adhere to API guidelines of the provider of the software service. As APIs provide critical functionality to software services, software service providers typically utilize API guidelines to ensure that developers working on the API create endpoints that are consistent with a framework laid out in the API guidelines. Such a framework may include best practices, rules directing the use of various parameters that may be utilized in the endpoints for the API, among other possibilities. Accordingly, the computing platform 300 may, via the API guidelines enforcement tool 320 of the API validation suite 310, (i) ingest API guidelines of the service provider of the API, (ii) monitor the development of endpoints of the API, and (iii) alert developers working on the API when they veer away from the API guidelines of the service provider of the API, among various other possibilities.

In some implementations, the tools 312-320 of the API validation suite 310 may be performed in a particular order. For example, in some implementations, the computing platform 300 may perform operations of the completeness validation tool 312 before the operation of other tools, such as the accuracy validation tool 314. This may ensure that subsequent tests of certain of the tools 312-320 are valid. For example, a validation of the accuracy of tests created for the API (i.e., via the accuracy validation tool 314) may be unreliable if the OAS for the API is not first validated to be complete, which may be determined via performing the operations of the completeness validation tool 312. Various other examples, including particular orders for performing the operations of the various tools 312-320, are also possible. As may be appreciated, this may also be true for the auto-test creation tool 322, the surface area test coverage tool 324, and the test versus production comparison tool 326 of the API validation suite 310, each of which are described in greater detail below.

FIG. 4 is a simplified block diagram illustrating the computing platform 300 performing operations of the auto-test creation tool 322 of the API validation suite 310, according to the present disclosure.

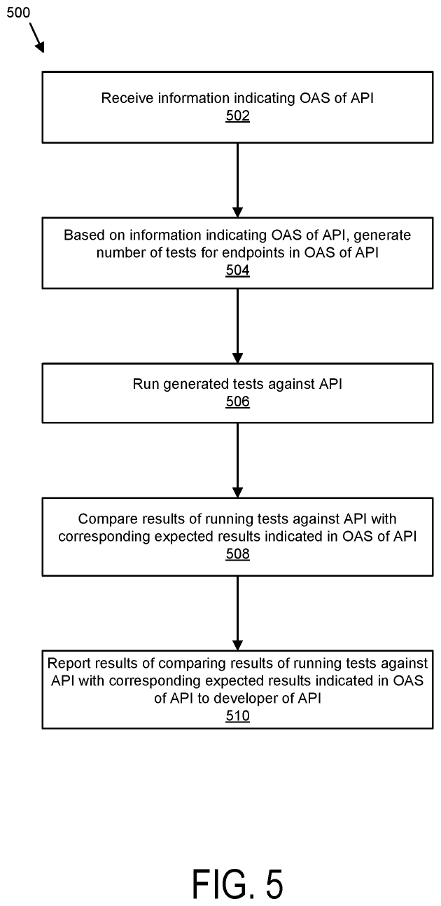

The computing platform 300 may utilize the auto-test creation tool 322 to automatically generate tests for the API that are based on the OAS of the API. As described in greater detail in FIG. 5, the computing platform 300 may initially receive information 400 indicating the OAS of the API. Based on the information 400 indicating the OAS of the API, among other things, the computing platform 300 may, via the auto-test creation tool 322 of the API validation suite 310, automatically generate a number of tests for the API. Further details regarding how the computing platform 300 determines the extent of tests to automatically generate based on the received information 400 indicating the OAS of the API are described with respect to FIG. 5.

In addition to automatically generating tests for the API based on the information 400 indicating the OAS of the API, the computing platform 300 may, via the auto-test creation tool 322 of the API validation suite 310, run the automatically generated tests against the API in a testing environment to determine whether the automatically generated tests accurately reflect the operations of the API. The computing platform 300 may then output results 402 of the operations of the auto-test creation tool 322, as described in further detail below.

Turning now to FIG. 5, a flowchart 500 is shown that illustrates various operations that may be carried out by the computing platform 300, according to the present disclosure. For example, the operations of the flowchart 500 may be performed via the auto-test creation tool 322 of the API validation suite 310 of the computing platform 300.

Beginning at block 502, the computing platform 300 may receive information indicating the OAS of the API. The information may be received from various sources, such from the data storage 304 of the computing platform 300, among various other sources, which may be internal and external to the computing platform 300.

As previously described, the OAS may include documentation that describes the endpoints of the API in a format that is both human-readable and software-readable. For example, the OAS may include a number of json objects, each of which may describe a respective endpoint of the API. The description of a given json object for a respective endpoint may include (i) a verb of the respective endpoint (e.g., POST, GET, PUT, PATCH, DELETE, etc.), (ii) a description of the functionality of the respective endpoint, (iii) a list of parameters that may be required or permissible inputs in calling the endpoint, such as header parameters, path parameters, and query parameters, and (iv) a list of the possible responses of the respective endpoint, such as (a) informational responses (type 100 responses), (b) successful responses (type 200 responses), (c) redirection messages (type 300 responses), (d) client error responses (type 400 responses), (e) server error responses (type 500 responses), and/or (f) any default responses, among various other things.

The OAS may also take various other forms in addition to or instead of a number of json objects. For example, the OAS may be available as a part of a website accessible to developers and other users of the API. Various other possibilities may also exist.

In some implementations, the computing platform 300 may receive information that indicates various portions of the OAS of the API. As one possibility, the computing platform 300 may receive information that indicates the entirety of the OAS of the API. In some implementations, the computing platform 300 may receive this information as a default option, for example, in the absence of instructions indicating that a different portion of the OAS of the API should be received, rather than the entirety.

As another possibility, the computing platform 300 may receive information that indicates a portion that is less than the entirety of the OAS of the API. For instance, in some implementations, a user of the computing platform 300 may input instructions that define a specific portion of the OAS of the API that should be received. For example, such instructions may define a particular category of endpoints that are to be received. Such categories may take various forms, such public endpoints, private endpoints, endpoints that are relevant to a certain type of functionality of the software service associated with the API, among various other possible forms.

At block 504, the computing platform 300 may, via the auto-test creation tool 322 of the API validation suite 310 and based on the information indicating the received OAS, automatically generate one or more tests for the endpoints in the OAS of the API.

The computing platform 300 may, via the auto-test creation tool 322 of the API validation suite 310, parse through the information indicating the OAS to identify endpoints of the OAS to generate one or more tests for. For example, the computing platform 300 may, for a given endpoint of the API represented in the OAS, identify the various response types that the given endpoint may return based on various parameters that the given endpoint is configured to receive. The computing platform 300 may then, based on the various response types of the given endpoint, as well as the various parameters that may be accepted by the given endpoint, automatically generate a set of tests for the given endpoint. For example, each respective test of the set of tests for the given endpoint may include a request with a number of test parameters that may or may not be accepted by the given endpoint, as well as a corresponding expected response that the given endpoint may be expected to return in response to the respective test, for example, based on the various response types of the given endpoint.

The set of tests for the given endpoint may test the given endpoint to varying degrees. As one possibility, and perhaps as a default option, the set of tests created by the computing platform 300 via the auto-test creation tool 322 of the API validation suite 310 may be a comprehensive testing of the given endpoint. As another possibility, the set of tests may test a portion, but not all, of the given endpoint. For example, the computing platform 300 may be configured to create a set of tests for the given endpoint that test a certain type of response, such as type 500 responses. As another example, the computing platform 300 may be configured to identify existing tests for the given endpoint, such as tests for a portion of the given endpoint that have been manually created and performed by a developer of the API. Accordingly, the computing platform, via the auto-test creation tool 322, may create a set of tests for the given endpoint that do not include tests for the portions of the given endpoint that have already been tested. Various other possibilities may also exist.

In practice, the computing platform 300 may, via the auto-test creation tool 322 of the API validation suite 310, create sets of tests for different endpoints of the API represented in the OAS. As one possibility, the computing platform 300 may create a set of tests for each endpoint that is described in the OAS of the API. For example, the computing platform 300 may create tests for every endpoint as a default option, or otherwise when the computing platform 300 receives an entirety of the OAS in block 502. Further, the respective set of tests for each endpoint described in the OAS of the API may include tests for various portions of each endpoint, as previously described.

As another possibility, the computing platform 300 may create a set of tests for only a portion of the endpoints in the OAS of the API. As one example, the computing platform 300 may create a set of tests for a specific category of endpoints, as previously described. The computing platform 300 may do so, for instance, when the computing platform 300 receives only a portion of the OAS, such as a specific category of endpoints of the OAS, as previously described.

As another example, the computing platform 300 may create a set of tests for any of the endpoints in the OAS of the API that are not already tested, or that are not adequately tested. For instance, the computing platform 300 may be configured to determine which endpoints described in the OAS of the API have tests associated with them, which may have been generated by a developer or the like. The computing platform 300 may then, for example via the accuracy validation tool 314 as previously described, determine gaps in the tests for the endpoints in the OAS of the API that may indicate (i) portions of respective endpoints that are not tested, as well as (ii) any inaccuracies in the tests for the endpoints in the OAS of the API. Accordingly, the computing platform 300 may create tests via the auto-test creation tool 322 to cover the gaps in the testing coverage, for example, by creating tests that (i) test previously untested endpoints in the OAS of the API, (ii) test previously untested portions of previously tested endpoints in the OAS of the API, and/or (iii) correct inaccuracies in existing tests for endpoints in the OAS of the API, among various other possibilities. Further, some or all of the tests generated in block 504 may include various permutations that may incrementally alter parameters that are included in requests of the tests.

At block 506, the computing platform 300 may, via the auto-test creation tool 322 of the API validation suite 310, run the tests generated in block 504 against the API. In practice, these tests may be run in any appropriate testing framework (e.g., Request RSpec). In such a testing framework, the computing platform 300 may, via the auto-test creation tool 322 and execute each test generated in block 504 against the API. This may include (i) submitting the request of each test to the API and (ii) receiving a corresponding response for each test from the API. As may be appreciated, this process may be repeated for each of the tests generated in block 506.

At block 508, the computing platform 300 may, via the auto-test creation tool 322 of the API validation suite 310, compare the results of running the tests against the API with corresponding expected results indicated in the OAS of the API.

In some implementations, the computing platform 300 may identify a match between (i) a given response received from the API based on a given test request and (ii) an expected response of the given test. Accordingly, the computing platform 300 may determine that the given test, and consequentially, the portion of the OAS that the given test was derived from, accurately reflect the expected operations of the API with respect to the given request.

Further, in some implementations, the computing platform 300 may identify a discrepancy between (i) a given response received from the API based on a given test request and (ii) an expected response of the given test. Accordingly, the computing platform 300 may determine that the given test, and consequentially, the portion of the OAS that the given test was derived from, do not accurately reflect the operations of the API with respect to the given request.

At block 510, the computing platform 300 may, via the auto-test creation tool 322 of the API validation suite 310, report the results of comparing the results of running the automatically generated tests against the API with the corresponding expected results indicated in the OAS of the API. The results may be reported, for example, to a developer of the API. In practice, this report may take any of various forms. As one example, the report of the results may take the form of a graphical representation of the results of running the automatically generated tests against the

API, for example, as part of a dashboard view that may be accessible to developers for review. Various other possibilities may also exist.

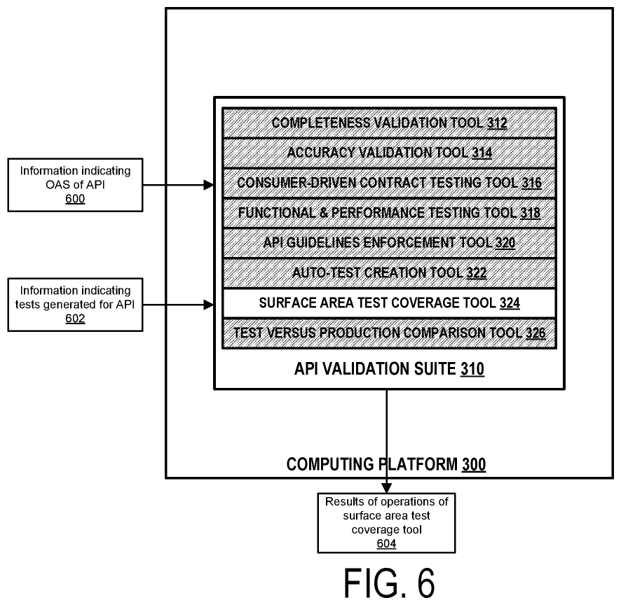

FIG. 6 is a simplified block diagram illustrating the computing platform 300 performing operations of the surface area test coverage tool 324 of the API validation suite 310, according to the present disclosure.

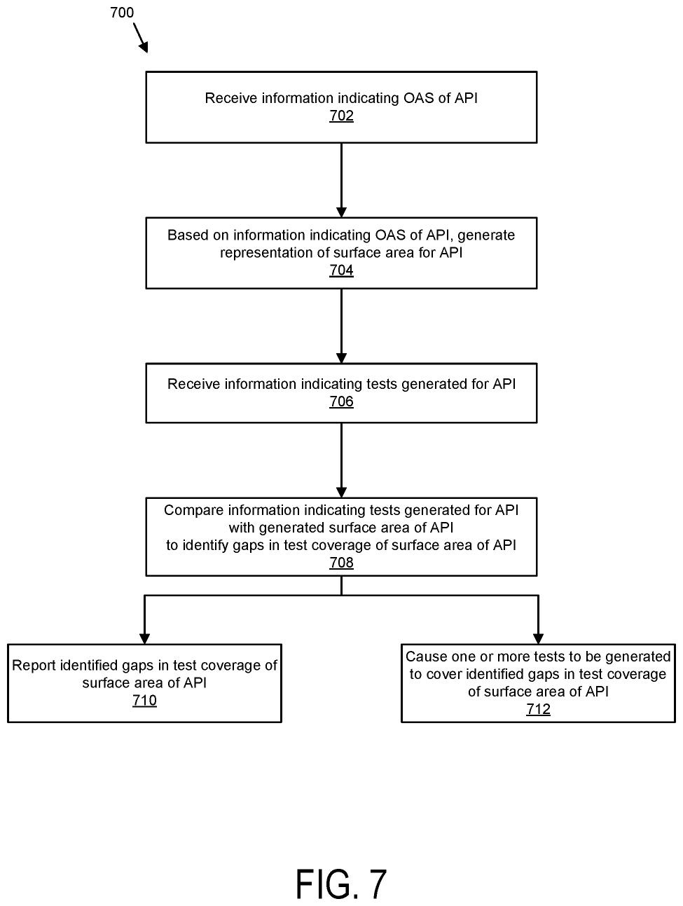

The computing platform 300 may utilize the surface area test coverage tool 324 of the API validation suite 310 to determine the surface area of the API, which, as described in greater detail below, may reflect the behaviors of the API. Further, the computing platform 300 may utilize the surface area test coverage tool 324 to determine what portions of the surface area of the API are adequately tested, and consequentially, what portions of the surface area of the API are not adequately tested. As described in greater detail below, the computing platform 300 may initiate this process by receiving (i) information 600 indicating the OAS of the API, as well as (ii) information 602 indicating tests that have been generated for the API. The computing platform 300 may then, via the surface area test coverage tool 324 of the API validation suite 310, (i) generate the surface area of the API based at least in part on the information 600 indicating the OAS of the API, among other things, and then (ii) compare the generated surface area with the information 602 indicating the tests that have been generated for the API to identify gaps in the testing coverage of the surface area of the API. The computing platform 300 may be configured to perform various operations based on the results of this comparison, such as (i) reporting the results to a developer of the API, along with other information that may assist the developer in determine what further actions to take based on the report, as well as (ii) automatically generating new tests to cover the gaps in the testing coverage of the surface area of the API. Some or all of these various operations based on the results of the comparison may make up results 604 of the operations of the surface area test coverage tool 324 of the API validation suite 310, which may be output by the computing platform 300 to various effects, depending on the nature of the results 604. Further details of the various operations of the surface area test coverage tool 324 are described in greater detail below, with respect to FIG. 7.

FIG. 7 is a flowchart 700 that illustrates various operations that may be carried out by the computing platform 300, according to the present disclosure. For example, the operations of the flowchart 700 may be performed by the computing platform 300 via the surface area test coverage tool 324 of the API validation suite 310.

Beginning at block 702, the computing platform 300 may receive information indicating the OAS of the API. In practice, the operations of block 702 may be similar to those described with respect to block 502 of FIG. 5. Further, although the computing platform 300 may receive the entirety of the OAS at block 702, although subsets of the entire OAS may also be received at block 702, as described with respect to block 502 of FIG. 5.

At block 704, the computing platform 300 may, via the surface area test coverage tool 324 of the API validation suite 310 and based on the information indicating the OAS of the API, generate a representation of the surface area for the API. As mentioned, the surface area for the API may reflect the behaviors of the API, including each response that the API may provide for each request that it may receive. Accordingly, the representation of the surface area may include a matrix, list, or other data structure that enumerates these behaviors for each endpoint of the API.

One example of information that may be included in the representation of the surface area for the API may be the verbs, descriptions, parameters, and expected responses that are included in the OAS for endpoints of the API. Another example of information that may be included in the surface area for the API may include descriptions for how the software service that the API interacts with will behave in light of (i) various parameters of a given endpoint, as well as (ii) any business logic of the software service. As used herein, business logic of the software service may refer to the rules and processes implemented by the software service that determine the manners in which the software service may transform information based on the various inputs (e.g., verb, path, parameters, etc.) that are included in the call of the given endpoint. As may be appreciated, the responses returned via the API in response to given endpoint requests may include information that has been determined based on the business logic of the software service, and how such business logic interacts with the various inputs included in received requests of the given endpoints. Various other examples of information that may be included in the surface area for the API may also be possible.

At block 706, the computing platform 300 may, via the surface area test coverage tool 324 of the API validation suite 310, receive information indicating tests that have been generated for the API.

As may be appreciated, the tests that have been generated and/or implemented for the API may originate from various sources. As one possibility, the tests may originate from developers of the API, as previously described. As another possibility, the tests may originate from the API validation suite 310, such as the automatically generated tests described with respect to FIGS. 4-5. The tests may also originate from various other sources, and the information indicating the tests that have been generated for the API may include information from any one of these sources, or optionally from some or all of these sources. For example, the tests that have been generated for the API may include a combination of tests that have been generated by developers of the API as well as tests that have been automatically generated by the computing platform 300, for example via the auto-test creation tool 322 of the API validation suite 310, as previously described. Various other possibilities may also exist.

Further, the tests that are indicated in the information received by the computing platform 300 at block 704 may correspond to various portions of the API. As one example, the computing platform 300 may be configured to utilize the surface area test coverage tool 324 of the API validation suite 310 for only a portion of the API, for example, for a certain category of endpoints of the API. In such cases, the computing platform 300 may receive information indicating tests that have been generated that relate to the certain category of endpoints of the API, and may not receive information indicating tests that have been generated that relate to other endpoints of the API. Alternatively, even in instances where the computing platform 300 may be configured to utilize the surface area test coverage tool 324 of the API validation suite 310 for only a portion of the API, the computing platform 300 may still receive information indicating tests that have been generated for the API that are not limited to those tests that relate to the portion of the API. In such cases, the computing platform 300 may identify the tests that relate to the portion of the API, and ignore other tests that have been received. As another example, the computing platform 300 may be configured to utilize the surface area test coverage tool 324 of the API validation suite 310 for the entirety of the API. In such cases, the computing platform 300 may receive information indicating all of the tests that have been generated for the API. Various other possibilities may also exist.

At block 708, the computing platform 300 may, via the surface area test coverage tool 324 of the API validation suite 310, compare the information indicating the tests that have been generated for the API received in block 706 with the representation of the surface area of the API that was generated in block 704 to identify gaps in the test coverage of the surface area of the API.

In practice, there may be various reasons why portions of the surface area of the API have not been adequately tested, leading to gaps in the test coverage of the surface area of the API. As one possibility, the computing platform 300 may not yet have performed operations of other validation tools, such as the accuracy validation tool 314 as previously described. As another example, the computing platform 300 may not yet have performed operations of the auto-test creation tool 322 of the API validation suite 310 for some or all of the API. In such cases, the testing of the API may only include those tests that were generated by developers of endpoints of the API, which may not yet have been validated as accurately reflecting the information in the OAS of the API.

As another possibility, there may be business logic of the software service that the API interacts with that may not be represented in the OAS of the API, which may cause tests generated via the auto-test creation tool 322 of the API validation suite 310 to not be reflective of said business logic, causing gaps in the testing coverage of the surface area of the API. Various other possibilities may also exist.

After identifying the gaps in the test coverage of the surface area of the API, the computing platform 300 may be configured to perform a variety of operations that may be based on the identified gaps in the test coverage. Block 710 describes one possible operation that may be performed by the computing platform 300 via the surface area test coverage tool 324 of the API validation suite 310, wherein the computing platform 300 may report the identified gaps in the test coverage of the surface area of the API, for example, to a developer of the API. In practice, this report may take any of various forms. As one example, the report of the gaps of the testing coverage of the surface area of the API may take the form of a graphical representation of the gaps of the testing coverage of the surface area of the API, for example, as part of a dashboard view that may be accessible to developers for review. The report of the gaps of the testing coverage of the surface area of the API may take various other forms as well.

Further, the report may include various details for developers to review. One detail may include information indicating the identified gaps in the test coverage of the surface area of the API. Such information may indicate the tests that exist for the surface area of the API, as well as the portions of the surface area of the API that are not adequately tested. For example, the information may indicate what tests are inaccurate or incomplete, and the resulting portions of the surface area of the API that are thereby not adequately tested. Another detail may include information indicating a significance of certain gaps in the testing coverage of the surface area of the API, so that the developer may determine whether testing coverage of those certain gaps is needed. The report may include various other details.

Block 712 describes another possible operation that may be performed by the computing platform 300 via the surface area test coverage tool 324 of the API validation suite 310, wherein the computing platform 300 may cause one or more tests to be generated to cover the identified gaps of the testing coverage of the surface area of the API. In practice, the computing platform 300 may be configured to perform the operations of block 712 in addition to, or instead of, the operations of block 710. In some implementations, this may depend on configuration settings that may be established for the computing platform 300, for example, by a user of the computing platform 300.

In practice, the computing platform 300 may, via the surface area test coverage tool 324 of the API validation suite 310, cause the one or more tests to be generated to cover the gaps of the testing coverage of the surface area of the API in various ways. As one possibility, the computing platform 300 may provide, as part of the report described above with respect to block 710 or otherwise, a prompt instructing a developer of the API to generate one or more tests to cover the gaps of the testing coverage of the surface area of the API. Such a prompt may include information that may be utilized by the developer of the API to determine (i) whether to generate the one or more tests, as well as (ii) in what manner to generate the one or more tests. For example, in implementations where full test coverage of the API may not be necessary, the prompt may include information that may provide the developer of the API with an indication of a relative significance of certain gaps in the testing coverage of the surface area of the API, so that the developer may determine which tests to generate, and which tests may not need to be generated. As another example, the prompt may include information that may guide the developer in generating the one or more tests, such as by providing templates or other information that may be utilized by the developer to generate the one or more tests. As yet another example, the prompt may include an indication of one or more tests that the computing platform 300 may automatically generate, as described in further detail below, for the developer to review and either approve for implementation or reject. Along with the indication of the one or more tests automatically generated by the computing platform 300, the prompt may further include information indicating a description as to how the one or more automatically generated tests may cover the gaps in the test coverage of the surface area of the API. Various other examples may also exist.

As another possibility, the computing platform 300 may cause the auto-test creation tool 322 of the API validation suite 310 to generate tests to cover the gaps of the testing coverage of the surface area of the API. In some implementations, this may include performing one or more of the operations described in the flowchart 500 of FIG. 5. In such implementations, the operations of block 502 may include receiving information indicating portions of the OAS of the API that may be associated with gaps in the testing coverage of the surface area of the API.

Further, in some implementations, some or all of the gaps in the testing coverage of the surface area of the API may be at least partially based on business logic of the software service that the API interacts with that is not represented in the OAS of the API. In such implementations, the computing platform 300 may cause the auto-test creation tool 322 of the API validation suite 310 to ingest information indicating the business logic of the software service that may account for the gaps in the testing coverage of the surface area of the API. In such implementations, the auto-test creation tool 322 of the API validation suite 310 may be configured to utilize the information indicating the business logic of the software service to automatically generate tests to cover the gaps in the testing coverage of the surface area of the API. Various other possibilities may also exist.

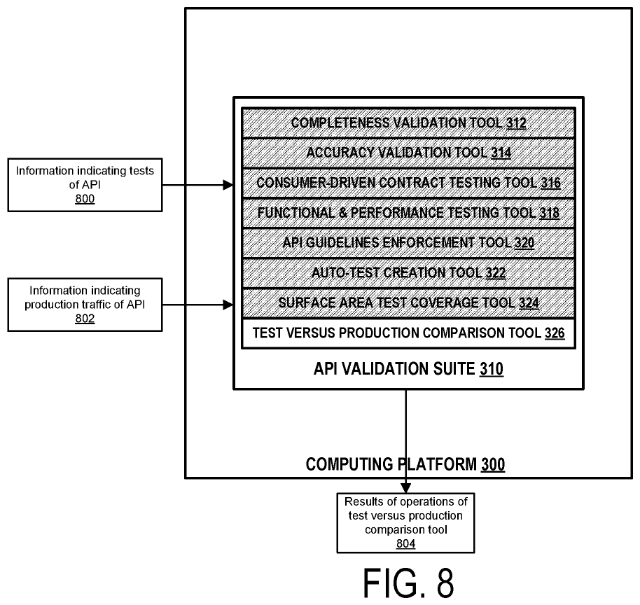

FIG. 8 is a simplified block diagram illustrating the computing platform 300 performing operations of the test versus production comparison tool 326 of the API validation suite 310, according to the present disclosure.

The computing platform 300 may utilize the test versus production comparison tool 326 of the API validation suite 310 as a mechanism for determining a set of API contracts from tests that have been generated and executed against the API, for example in a testing environment, as well as a set of API contracts that exist from production traffic of the API, and then comparing the two sets to determine various insights regarding the test coverage of the tests that have been generated and executed against the API, among various other things. As described in greater detail below, the computing platform 300 may initiate this process by receiving, via the test versus production comparison tool 326 of the API validation suite 310, (i) information 800 indicating tests that have been generated and executed against the API and (ii) information 802 indicating production traffic of the API. The computing platform 300 may then, via the test versus production comparison tool 326 of the API validation suite 310, compare API test contracts generated from the information 800 indicating the tests that have been generated and run against the API with API production contracts generated from the information 802 indicating the production traffic of the API to determine various insights. Such insights may include identifying certain production traffic of the API that may not represented by a test that has been generated and executed against the API or certain tests that have been generated and executed against the API that are underutilized in production of the API, among various other things. The computing platform 300 may further be configured to perform various additional operations, such as reporting results 804 of the operations of the test versus production comparison tool 326 of the API validation suite 310, for example to developers of the API, among various other additional operations that are described in greater detail below.

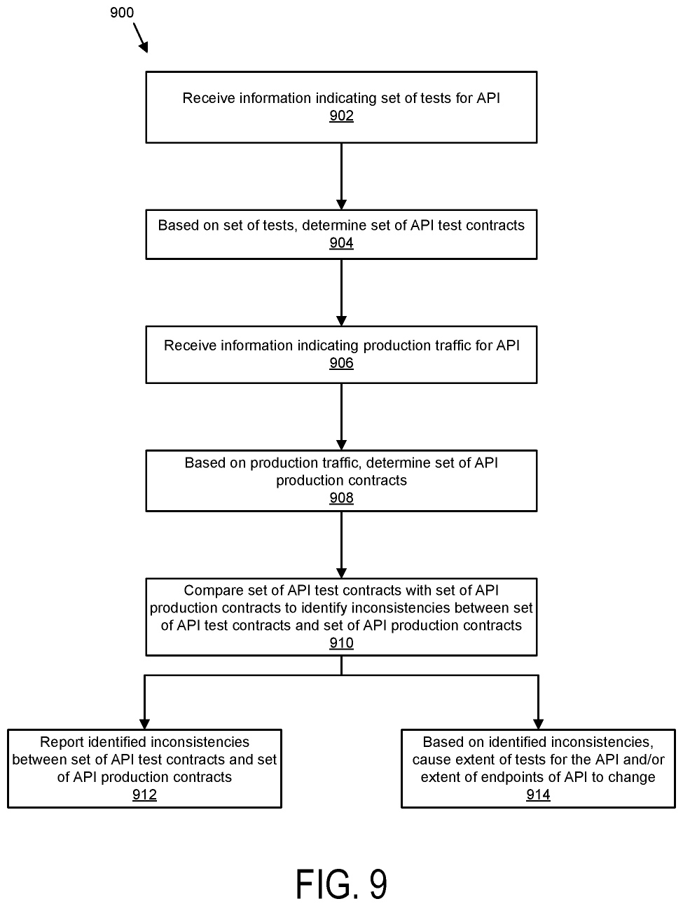

FIG. 9 is a flowchart 900 that illustrates various operations that may be carried out by the computing platform 300, according to the present disclosure. For example, the operations of the flowchart 900 may be performed by the computing platform 300 via the test versus production comparison tool 326 of the API validation suite 310.

Beginning at block 902, the test versus production comparison tool 326 of the API validation suite 310 may receive information indicating tests that have been generated and executed against the API. As may be appreciated, these tests may be generated and executed by developers of the API, automatically generated and executed by the computing platform 300, for example via the auto-test creation tool 322 or possibly the surface area test coverage tool 324, as previously described, among various other possibilities.

As previously described, the tests generated and executed against the API indicated in the information received at block 902 may each include (i) a respective request to the API and (ii) a respective response from the API that is given based on the respective request to the API. The respective request may include various types of information. One type of information that may be included in the respective request may be a verb that defines a requested operation to be performed by the API (e.g., POST, GET, PUT, PATCH, DELETE, etc.). Another type of information that may be included in the respective request may be a path that defines where, for example where within data storage system of the software service associated with the API, actions defined by the respective request should be performed by the API. Yet another type of information that may be included in the respective request may be various parameters that may inform any business logic of the API's associated software service as to what transformations are to be performed on certain data based on the respective request to the API. Further, the respective response from the API that is given based on the respective request to the API may include (i) information requested in the respective request, and/or (ii) status information indicating a status of the respective response, such as whether the respective response succeeded or failed, among other possibilities.

Further, the extent of tests that are indicated in the information received at block 902 may vary, as previously described. For example, the computing platform 300 may be configured to receive only a portion of the tests that have been generated and executed against the API, such as those that relate to a specific category of endpoints of the API, which a user of the computing platform 300 may be interested in testing. Various other possibilities exist.

Further yet, in some implementations, the computing platform 300 may be configured to, via the test versus production comparison tool 326, execute any tests indicated in the information received at block 902 that have been previously generated, but that have not yet been executed against the API. In practice, such operations may be similar to those described with the respect to the auto-test creation tool 322 of the API validation suite 310, for example as described with respect to the flowchart 500 of FIG. 5.

At block 904, the computing platform 300 may, via the test versus production comparison tool 326 and based on the information indicating the tests that have been generated and executed against the API, determine a set of API test contracts. An API test contract may be defined by the relationship between (i) a respective request identified in a respective test indicated in the information received at block 902 and (ii) a corresponding respective response from the API that is identified in the respective test indicated in the information received at block 902. For example, an API test contract may embody the expectation that a developer may have that executing a test against the API with a given input (e.g., a given verb, path, and parameters) will result in receiving a given response from the API.

At block 906, the computing platform 300 may, via the test versus production comparison tool 326, receive information indicating production traffic of the API.

The production traffic of the API may refer to requests (e.g., calls) to the API by consumers

of the API outside of a testing environment, for example, as well as responses returned via the API based on those requests. Consumers of the API may include the developers of the API, as well as other internal and external consumers, as previously described.

Further, the information that indicates the production traffic of the API may take any of various forms. As one possibility, the information indicating the production traffic may include the actual requests and responses that exist in the production traffic of the API. However, such information may be confidential, private, or otherwise unavailable for use by the computing platform 300. Accordingly, and as another possibility, the information indicating the production traffic of the API may include obfuscated renditions of the requests and responses that exist in the production traffic of the API to remove any confidential or private information, while still retaining sufficient structure to be usable by the computing platform 300 to perform the operations of the test versus production comparison tool 326 of the API validation suite 310. To this end, the computing platform 300 may utilize a key or the like to make use of the obfuscated renditions of the requests and responses.

Further yet, the information that indicates the production traffic of the API may take various forms. As one example, the information may indicate production traffic for various portions of the API, such as certain categories of endpoints of the API that a user of the computing platform 300 may desire to test via the API validation suite 310. As another example, the information may indicate production traffic from various periods of time, such as production traffic of the API from the past day, week, month, quarter (e.g., 3 month period), etc. The production traffic indicated by the information received at block 906 may take other forms as well.

At block 908, the computing platform 300 may, via the test versus production comparison tool 326 of the API validation suite 310 and based on the information indicating the production traffic of the API received at block 906, determine a set of API production contracts. An API production contract may be defined by the relationship between (i) a respective request to the API that is identified in the information indicating the production traffic of the API received at block 906 and (ii) a corresponding response from the API that is identified in the information indicating the production traffic of the API received at block 906. For example, an API production contract may embody the expectation that a consumer of the API may have that calling an endpoint of the API with a given request (e.g., a given verb, path, and parameters) will result in receiving a given response from the API.

At block 910, the computing platform 300 may, via the test versus production comparison tool 326 of the API validation suite 310, compare the set of API test contracts with the set of API production contracts to identify inconsistencies between the sets.

In practice, there may be various types of inconsistencies that the computing platform 300 may identify in block 910. As one possibility, the computing platform 300 may, via the test versus production comparison tool 326, identify API test contracts of the set of API test contracts that are not reflected in the set of API production contracts. For example, there may be API test contracts in the set of API test contracts that represent the requests and responses of respective tests generated and executed against the API that are not seen in the production traffic of the API. Such an absence in the production traffic of the API may signify, among various other things, that portions of the API are not being utilized by consumers of the API.

To illustrate with an example, the computing platform 300 may, via the test versus production comparison tool 326 of the API validation suite 310, perform operations of blocks 902-908 to generate a set of API test contracts for a given endpoint of the API, as well as a set of API production contracts that represents the requests and responses of the API in the production traffic of the API over a given period of time. At block 910, the computing platform 300 may, via the test versus production comparison tool 326, determine that the set of API test contracts for the given endpoint of the API is not represented in the set of API production contracts. This may indicate that the given endpoint of the API has not been utilized in the production traffic of the API during the given period of time.

As another possibility, the computing platform 300 may, via the test versus production comparison tool 326, identify API production contracts of the set of API production contracts that are not reflected in the set of API test contracts. For example, there may be API production contracts in the set of API production contracts that represent requests and corresponding responses in the production traffic of the API that are not seen in the tests that have been generated and executed for the API. Such an absence in the tests generated and executed for the API may signify, among various other things, that some of the requests to and/or responses from endpoints of the API that exist in the production traffic of the API are not adequately tested.

To illustrate with an example, the computing platform 300 may, via the test versus production comparison tool 326, perform operations of blocks 902-908 to generate a set of API test contracts that may reflect all of the tests that have been generated and executed against the API over a given period of time, as well as a set of API production contracts that represents the requests and responses of the API in the production traffic of the API over the given period of time. At block 910, the computing platform 300 may, via the test versus production comparison tool 326, determine that one or more API production contracts of the set of API production contracts are not represented in the set of API test contracts. This may indicate that certain requests to and/or responses from the API that exist in the production traffic of the API are not adequately tested. For instance, requests to a given endpoint of the API that include one or more parameters on which the given endpoint of the API has not been tested may indicate that the developer of the given endpoint of the API may not have considered that such parameters would be included in requests to the given endpoint. In such instances, the responses from the given endpoint of the API may be inconsistent, unreliable, or otherwise unknown. Alternatively, the determination that one or more API production contracts of the set of API production contracts are not represented in the set of API test contracts may be indicative of an incomplete OAS. For instance, if the set of API test contracts is based on tests generated automatically via the computing platform 300, which are in turn based on the OAS, then this discrepancy may indicate that the OAS has a gap in it. In such cases, the API may support functionality (e.g., the functionality utilized in production) that is not reflected in the OAS.

After identifying inconsistencies between the set of the API test contracts and the set of the API production contracts, the computing platform 300 may be configured to perform a variety of operations that may be based on the identified inconsistencies between the sets. Block 912 describes one possible operation that may be performed by the computing platform 300 via the test versus production comparison tool 326, wherein the computing platform 300 may report information indicating the identified inconsistencies between the sets, for example, to a developer of the API. In practice, this report may take any of various forms. As one example, the report of the identified inconsistencies between the sets may take the form of a graphical representation of the identified inconsistencies between the sets, for example, as part of a dashboard view that may be accessible to developers for review. The report of the identified inconsistencies between the sets may take various other forms as well.

Further, the report may include various details for developers to review. One detail may include information indicating the inconsistencies in the sets of API contracts. Such information may indicate which API production contracts are not reflected in the set of API test contracts, which API test contracts are not reflected in the set of API production contracts, etc. From these, further conclusions may be drawn by the computing platform 300 and included in the report. For example, from the information indicating which API production contracts are not reflected in the set of API test contracts, the computing platform 300 may determine, and report, certain parameters that are being utilized in production for certain endpoints of the API that have not been tested. As another example, the computing platform 300 may determine and report, based on the information indicating which API test contracts are not reflected in the set of API production contracts, certain endpoints (or portions of a given endpoint) that are not being utilized in production.

Another detail may include information indicating a relative significance of certain inconsistencies between the sets of API contracts. As one example, if an API production contract is found multiple times in production traffic of the API, but does not have a corresponding API test contract in the set of API test contracts, then the computing platform 300 may determine and report that the requests and/or results of the API production contract are of a relatively high significance. Alternatively, if the API production contract is only sparsely found in the production traffic of the API, then the computing platform 300 may determine and report that the requests and/or results of the API production contract are of a relatively lower significance.

Similar details may be included with respect to the significance of API test contracts that are not reflected in the set of API production contracts. For example, if the API test contracts that represent the tests that have been generated and executed against the API for a particular portion of an endpoint or a particular endpoint of the API are not reflected in the set of API production contracts, then the computing platform 300 may determine and report that the particular portion of the endpoint or the particular endpoint of the API are not being utilized in production. The computing platform 300 may include indications as well that describe how long it has been since API production contracts corresponding to certain API test contracts have been identified in the production traffic API, which may give developers further insight into the significance of the certain API test contracts. The report may include various other details as well.

Block 914 describes another possible operation that may be performed by the computing platform 300 via the test versus production comparison tool 326, wherein the computing platform 300 may update the tests that are generated and executed against the API and/or update the endpoints of the API, based on the identified inconsistencies between the set of API test contracts and the set of API production contracts. In practice, the computing platform 300 may be configured to perform the operations of block 914 in addition to or instead of the operations of block 912. In some implementations, this may depend on configuration settings that may be established for the computing platform 300, for example, by a user of the computing platform 300.

As mentioned, the computing platform 300 may, via the test versus production comparison tool 326 of the API validation suite 310, update the tests that are generated and executed against the API by causing one or more supplemental tests to be generated and executed against the API. For instance, the computing platform 300 may cause one or more supplemental tests to be generated and executed against the API in implementations where there are API production contracts in the set of production contracts determined at block 906 that are not reflected in the set of API test contracts determined at block 902.

In practice, the computing platform 300 may cause supplemental tests to be generated and executed against the API in various ways, which in some implementations may be similar to the manners in which the computing platform 300 may cause one or more tests to be generated to cover identified gaps of the testing coverage of the surface area of the API, as described with respect to block 712 of FIG. 7.

As one possibility, the computing platform 300 may provide, as part of the report of block 912 or otherwise, a prompt instructing a developer of the API to generate and execute one or more supplemental tests against the API. Such a prompt may include information that may be utilized by the developer of the API to determine (i) whether to generate the one or more supplemental tests, as well as (ii) in what manner to generate the one or more supplemental tests. For instance, in implementations where the API production contracts that are not reflected in the set of API test contracts are representative of requests and/or responses only sparsely found in production traffic of the API, then the prompt may include information that may provide the developer of the API with an indication of a relatively low significance of those API production contracts, so that the developer may determine whether or not to generate and execute certain supplemental tests against the API. In a like manner, the prompt may also include information indicating a relatively high significance of API production contracts that are representative of requests and/or responses that are found more frequently in the production traffic of the API. Further, it should be noted that although the significance of certain requests and/or responses has been described as being based on the frequency of the occurrence of the certain requests and/or responses in the production traffic of the API, in some implementations, various other factors may determine the significance of certain requests and/or responses.

As another example, the prompt may include information that may guide the developer in generating the one or more supplemental tests, such as by providing templates or other information that may be utilized by the developer to generate the one or more tests. As yet another example, the prompt may include an indication of one or more supplemental tests that the computing platform 300 may automatically generate, as described in further detail below, for the developer to review and approve for implementation or reject. Along with the indication of the one or more supplemental tests automatically generated by the computing platform 300, the prompt may further include information indicating a description as to how the one or more automatically generated supplemental tests may remedy the inconsistencies between the set of API test contracts and the set of API production contracts. Various other examples may also exist.

As another possibility, the computing platform 300 may cause the auto-test creation tool 322 of the API validation suite 310 to generate and execute one or more supplemental tests to remedy the inconsistencies between the set of API test contracts and the set of API production contracts. In some implementations, this may include performing one or more of the operations described in the flowchart 500 of FIG. 5, in addition to receiving information indicating the API production contracts that are not represented in the set of API test contracts.

Regardless of the manner in which the computing platform 300 causes one or more supplemental tests to be generated and executed against the API, the computing platform 300 may, via the test versus production comparison tool 326, verify that the one or more supplemental tests remedy the inconsistencies identified between the set of API production contracts and the set of API test contracts. In practice, the computing platform 300 may accomplish this by adding the one or more API test contracts that represent the one or more supplemental tests to the set of API test contracts, and then compare the updated set of API test contracts with the set of API production contracts to determine whether the previously identified inconsistencies remain, or whether they have been resolved by the addition of the new API test contracts that represent the one or more supplemental tests.

In addition to or instead of updating the tests that are generated and executed against the API, the computing platform 300 may, via the test versus production comparison tool 326, update the endpoints of the API. For instance, the computing platform 300 may cause one or more endpoints of the API, or one or more portions of an endpoint of the API, to be deprecated, for example, to save on costs associated with maintaining operations of the one or more endpoints of the API.

In practice, the computing platform 300 may cause endpoints to be deprecated in a manner that is similar to how the computing platform 300 may cause one or more tests to be generated and executed against the API, as previously described. As one example, prompts may be sent to developers including information indicating which endpoints are not being utilized in production, as evidenced by the absence of API production contracts that reflect certain API test contracts of the set of API test contracts. Such prompts may include information similar to the prompts previously described, such as information guiding the user as to which endpoints to deprecate, a relative significance of the endpoints that the computing platform 300 identifies as not being utilized in the production traffic of the API, among various other types of information.

As another example, the computing platform 300 may, via the test versus production comparison tool 326, automatically deprecate endpoints of the API that are not utilized in production. In some implementations, the computing platform 300 may be configured to determine whether certain endpoints of the API are utilized in production of the API according to some threshold (e.g., a usage threshold, a time threshold, a usage over time threshold, etc.). In such implementations, the computing platform 300 may be configured to automatically deprecate certain endpoints of the API that do not meet the threshold. In practice, this may be determined by identifying the inconsistencies in the set of API test contracts and the set of API production contracts, as described in block 910, and determining the extent to which API test contracts of the set of API test contracts that are representative of the certain endpoints of the API are reflected in the set of API production contracts. Various other possibilities may also exist.

The computing platform 300 may further, via the test versus production comparison tool 326, ensure that the OAS is updated to be consistent with any determinations or operations of the computing platform 300 via the test versus production comparison tool 326. As mentioned, the computing platform 300 may determine that one or more API production contracts of the set of API production contracts are not represented in the set of API test contracts, and further that the discrepancy is indicative of a gap in the OAS. Accordingly, as one example, the computing platform 300 may cause the OAS to be updated to include documentation to fill the gap, such as by describing functionality of endpoints of the API not previously included in the OAS. As may be appreciated, the computing platform 300 may cause the OAS to be updated in various ways, such as by (i) suggesting that a change needs to be made to particular portions of the OAS for a developer to address, (ii) suggesting particular changes to be made to the OAS for a developer to implement, such as what parameters, etc. need to be addressed, and/or (iii) preparing an updated OAS section for a developer of the API to add to the OAS, among various other possibilities.

Further, as mentioned, the computing platform 300 may determine that one or more API test contracts of the set of API test contracts are not represented in the set of API production contracts, and may cause one or more endpoints of the API, or one or more portions of an endpoint of the API, to be deprecated. Accordingly, as another example, the computing platform 300 may cause the OAS to be updated to remove documentation for deprecated endpoints of the API or deprecated portions of an endpoint of the API from the OAS. As may be appreciated, the computing platform 300 may cause the OAS to be updated in various ways, as previously mentioned.

To help describe some of these operations, flowcharts, such as the flowcharts 500, 700, and 900 of FIGS. 5, 7, and 9, may also be referenced to describe combinations of operations that may be performed by a computing device. In some cases, a block in any one of the flowcharts may represent a module or portion of program code that includes instructions that are executable by a processor to implement specific logical functions or steps in a process. The program code may be stored on any type of computer-readable medium, such as non-transitory computer readable media (e.g., the data storage 204 shown in FIG. 2). In other cases, a block in any one of the flowcharts may represent circuitry that is wired to perform specific logical functions or steps in a process. Moreover, the blocks shown in each of the flowcharts may be rearranged into different orders, combined into fewer blocks, separated into additional blocks, and/or removed, based upon the particular embodiment. Each flowchart may also be modified to include additional blocks that represent other functionality that is described expressly or implicitly elsewhere herein.

IV. CONCLUSION

Example embodiments of the disclosed innovations have been described above. Those skilled in the art will understand, however, that changes and modifications may be made to the embodiments described without departing from the true scope and spirit of the present invention, which will be defined by the claims.

Further, to the extent that examples described herein involve operations performed or initiated by actors, such as “users” or other entities, this is for purposes of example and explanation only. Claims should not be construed as requiring action by such actors unless explicitly recited in claim language. CLAIMS

1. A computing system comprising:
at least one processor;
a non-transitory computer-readable medium; and
program instructions stored on the non-transitory computer-readable medium that are executable by the at least one processor such that the computing system is configured to:
receive information indicating a set of tests that have been performed for an API, each test comprising a respective request to the API and a respective response from the API that collectively define an API test contract;
based on the set of tests, determine a set of API test contracts;
receive information indicating production traffic for the API, the production traffic comprising a set of requests to, and corresponding production responses from, the API, wherein each respective production request and corresponding production response collectively define an API production contract;
based on the production traffic for the API, determine a set of API production contracts;
compare the set of API test contracts with the set of API production contracts;
based on the comparison, determine an inconsistency between the set of API test contracts and the set of API production contracts; and
based on the determined inconsistency, cause a change in (i) an extent of the set of tests that have been performed for the API, or (ii) an extent of functionality of the API.

2. The computing system of claim 1, wherein the program instructions that are executable by the at least one processor such that the computing system is configured to determine the inconsistency between the set of API test contracts and the set of API production contracts comprise program instructions that are executable by the at least one processor such that the computing system is configured to determine that a given API production contract of the set of API production contracts is not reflected in the set of API test contracts.

3. The computing system of claim 2, wherein the program instructions that are executable by the at least one processor such that the computing system is configured to cause the change in the extent of the set of tests that have been performed for the API comprise program instructions that are executable by the at least one processor such that the computing system is configured to cause a supplemental test to be generated and performed for the API.

4. The computing system of claim 3, wherein the program instructions that are executable by the at least one processor such that the computing system is configured to cause the supplemental test to be generated and performed for the API comprise program instructions that are executable by the at least one processor such that the computing system is configured to automatically generate and perform the supplemental test for the API.

5. The computing system of claim 4, further comprising program instructions that are executable by the at least one processor such that the computing system is configured to:
determine a supplemental API test contract based on the supplemental test;
update the set of API test contracts to include the supplemental API test contract;
compare the given API production contract of the set of API production contracts with the updated set of API test contracts; and
based on the comparison, determine that the given API production contract is reflected in the updated set of API test contracts.

6. The computing system of claim 3, wherein the program instructions that are executable by the at least one processor such that the computing system is configured to cause the supplemental test to be generated and performed for the API comprise program instructions that are executable by the at least one processor such that the computing system is configured to report information to a user of the computing system, wherein the reported information instructs the user to generate the supplemental test.

7. The computing system of claim 1, wherein the program instructions that are executable by the at least one processor such that the computing system is configured to determine the inconsistency between the set of API test contracts and the set of API production contracts comprise program instructions that are executable by the at least one processor such that the computing system is configured to determine that a given API test contract of the set of API test contracts is not reflected in the set of API production contracts.

8. The computing system of claim 7, wherein the program instructions that are executable by the at least one processor such that the computing system is configured to cause the change in the extent of the functionality of the API comprise program instructions that are executable by the at least one processor such that the computing system is configured to cause an endpoint of the API to be deprecated.

9. The computing system of claim 1, wherein the production traffic represents production traffic of the API over a certain period of time, and wherein the set of tests comprises respective tests for various endpoints of the API.

10. The computing system of claim 1, further comprising program instructions that are executable by the at least one processor such that the computing system is configured to automatically generate a surface area of the API at least partially based on the set of tests.

11. The computing system of claim 1, further comprising program instructions that are executable by the at least one processor such that the computing system is configured to:
receive information indicating specification information for the API; and
automatically generate the set of tests based on the information indicating the specification information for the API.

12. A non-transitory computer-readable medium, wherein the non-transitory computer-readable medium is provisioned with program instructions that, when executed by at least one processor, cause a computing system to:
receive information indicating a set of tests that have been performed for an API, each test comprising a respective request to the API and a respective response from the API that collectively define an API test contract;
based on the set of tests, determine a set of API test contracts;
receive information indicating production traffic for the API, the production traffic comprising a set of requests to, and corresponding production responses from, the API, wherein each respective production request and corresponding production response collectively define an API production contract;
based on the production traffic for the API, determine a set of API production contracts;
compare the set of API test contracts with the set of API production contracts;
based on the comparison, determine an inconsistency between the set of API test contracts and the set of API production contracts; and
based on the determined inconsistency, cause a change in (i) an extent of the set of tests that have been performed for the API, or (ii) an extent of functionality of the API.

13. The non-transitory computer-readable medium of claim 12, wherein the program instructions that, when executed by at least one processor, cause the computing system to determine the inconsistency between the set of API test contracts and the set of API production contracts comprise program instructions that, when executed by at least one processor, cause the computing system to determine that a given API production contract of the set of API production contracts is not reflected in the set of API test contracts.

14. The non-transitory computer-readable medium of claim 13, wherein the program instructions that, when executed by at least one processor, cause the computing system to cause the change in the extent of the set of tests that have been performed for the API comprise program instructions that, when executed by at least one processor, cause the computing system to cause a supplemental test to be generated and performed for the API.

15. The non-transitory computer-readable medium of claim 14, wherein the program instructions that, when executed by at least one processor, cause the computing system to cause the supplemental test to be generated and performed for the API comprise program instructions that, when executed by at least one processor, cause the computing system to automatically generate and perform the supplemental test for the API.

16. The non-transitory computer-readable medium of claim 15, wherein the non-transitory computer-readable medium is also provisioned with program instructions that, when executed by at least one processor, cause the computing system to:
determine a supplemental API test contract based on the supplemental test;
update the set of API test contracts to include the supplemental API test contract;
compare the given API production contract of the set of API production contracts with the updated set of API test contracts; and
based on the comparison, determine that the given API production contract is reflected in the updated set of API test contracts.

17. The non-transitory computer-readable medium of claim 14, wherein the program instructions that, when executed by at least one processor, cause the computing system to cause the supplemental test to be generated and performed for the API comprise program instructions that, when executed by at least one processor, cause the computing system to report information to a user of the computing system, wherein the reported information instructs the user to generate the supplemental test.

18. The non-transitory computer-readable medium of claim 12, wherein the program instructions that, when executed by at least one processor, cause the computing system to determine the inconsistency between the set of API test contracts and the set of API production contracts comprise program instructions that, when executed by at least one processor, cause the computing system to determine that a given API test contract of the set of API test contracts is not reflected in the set of API production contracts.

19. A method carried out by a computing system, the method comprising:
receiving information indicating a set of tests that have been performed for an API, each test comprising a respective request to the API and a respective response from the API that collectively define an API test contract;
based on the set of tests, determining a set of API test contracts;
receiving information indicating production traffic for the API, the production traffic comprising a set of requests to, and corresponding production responses from, the API, wherein each respective production request and corresponding production response collectively define an API production contract;
based on the production traffic for the API, determining a set of API production contracts;
comparing the set of API test contracts with the set of API production contracts;
based on the comparison, determining an inconsistency between the set of API test contracts and the set of API production contracts; and
based on the determined inconsistency, causing a change in (i) an extent of the set of tests that have been performed for the API, or (ii) an extent of functionality of the APL

20. The method of claim 19, wherein determining the inconsistency between the set of API test contracts and the set of API production contracts comprises determining that a given API production contract of the set of API production contracts is not reflected in the set of API test contracts.
